(19) United States
(12) Patent Application Publication
(10) Pub. No.: US 2026/0235273 A1
(43) Pub. Date: Aug. 13, 2026

(54) LAMP MODULE FOR VEHICLE AND LAMP INCLUDING THE SAME

(71) Applicant: HYUNDAI MOBIS CO., LTD., Seoul (KR)

(72) Inventors: Na Ram JUN, Yongin-si (KR); Hyun Soo LEE, Yongin-si (KR); Tae Yang PARK, Yongin-si (KR); Sae Jun PARK, Gwangju-si (KR)

(73) Assignee: HYUNDAI MOBIS CO., LTD., Seoul (KR)

(21) Appl. No.: 19/400,573

(22) Filed: Nov. 25, 2025

(30) Foreign Application Priority Data
Feb. 7, 2025 (KR) 10-2025-0016025

(51) Int. Cl. F21S 43/20; F21S 43/27; F21V 5/00; F21V 5/04

(52) U.S. Cl. CPC F21S 43/26271; F21S 43/26231; F21S 43/26421; F21S 43/27; F21V 5/004; F21V 5/043

(57) ABSTRACT

A lamp module for a vehicle is provided. The lamp module includes a light source for emitting light, a bezel member to accommodate therein the light source; and a lens member fixed to a front side of the bezel member. The lens member includes cylinder lenses extending in an upward/downward direction and arranged in a leftward/rightward direction. Each of the cylinder lenses includes a cylinder incident surface into which light emitted from the light source is introduced, and a cylinder emergent surface spaced apart forward from the cylinder incident surface. An opening hole is formed in a front region of the bezel member, and the lens member is inserted into the opening hole. The bezel member includes an upper surface region, a lower surface region, and a front connection region for connecting the upper surface region and the lower surface region and defining the opening hole.

### CROSS-REFERENCE TO RELATED APPLICATION

This application claims priority to and the benefit under 35 USC § 119(a) of Korean Patent Application No. 10-2025-0016025 filed in the Korean Intellectual Property Office on February 7, 2025, the entire contents of which are incorporated herein by reference for all purposes.

### BACKGROUND

The present disclosure relates to a lamp module for a vehicle and a lamp including the same.

### 2. Description of the Related Art

With an increasing demand for aesthetic appearances of lamps for vehicles, structures of optical systems used for the lamps for vehicles have also been diversified. For example, recently, a demand for a lamp for a vehicle to which a micro-lens is applied has increased. For example, the micro-lens may be provided in the form of a micro-lens array or a micro cylinder lens and applied to the lamp for a vehicle. However, a lens structure to which the micro-lens is applied is restricted in size. As a result, in the related art, the lamp for a vehicle, to which the micro-lens is applied, is generally manufactured in such a way that a plurality of lamp modules to which the micro-lenses are applied are arranged.

However, in the related art, in case that the lamp for a vehicle has the plurality of lamp modules, a light-emitting surface is formed non-uniformly at a boundary between the adjacent lamp modules, which causes a problem of a deterioration in aesthetic appearance of the lamp.

### SUMMARY

The present disclosure has been made in an effort to solve a problem of a non-uniform light-emitting surface of a lamp for a vehicle to which a plurality of lamp modules are applied.

In order to achieve the above-mentioned object, one aspect of the present disclosure provides a lamp module for a vehicle, the lamp module including: a light source configured to emit light; a bezel member configured to accommodate therein the light source; and a lens member fixed to a front side of the bezel member, in which the lens member includes a plurality of cylinder lens units extending in an upward/downward direction H and arranged in a leftward/rightward direction W, in which the plurality of cylinder lens units each include: a cylinder incident surface into which light emitted from the light source is introduced; and a cylinder emergent surface spaced apart forward from the cylinder incident surface, in which an opened opening hole is formed in a front region of the bezel member, and the lens member is inserted into the opening hole, and in which the bezel member includes: an upper surface region configured to define an upper surface of the bezel member and extending in a forward/rearward direction A; a lower surface region configured to define a lower surface of the bezel member and extending in the forward/rearward direction A; and a front connection region configured to connect the upper surface region and the lower surface region and define the opening hole.

Shapes of horizontal cross-sections of the cylinder incident surfaces of some of the plurality of cylinder lens units may be different from shapes of horizontal cross-sections of the cylinder incident surfaces of some of the other cylinder lens units.

The bezel member and the lens member may be integrated.

The bezel member and the lens member may have different materials or colors.

The bezel member may include an opaque material, and the lens member may include a light transmissive material.

The bezel member and the lens member may include a light transmissive material, and the lamp module may further include a light-blocking layer provided on an outer or inner surface of the bezel member.

The bezel member may have a shape in which a width between the upper surface region and the lower surface region in the upward/downward direction H decreases forward.

A thickness in the leftward/rightward direction W of each of portions of the front connection region, which surround the opening hole and are provided on left and right portions of the opening hole, may be smaller than a thickness in the upward/downward direction H of each of portions of the front connection region that surround the opening hole and are provided on upper and lower portions of the opening hole.

The front connection region may be provided to surround upper and lower portions of the opening hole, and the opening hole is open in the leftward/rightward direction.

The cylinder incident surfaces of at least some of the plurality of cylinder lens units may each have a concave lens shape.

The cylinder incident surfaces of some of the other cylinder lens units may each have a convex lens shape.

The cylinder incident surfaces provided in the plurality of cylinder lens units may each have a concave lens shape.

In order to achieve the above-mentioned object, another aspect of the present disclosure provides a lamp for a vehicle, the lamp including: a plurality of lamp modules for a vehicle, in which the plurality of lamp modules for a vehicle are arranged in a leftward/rightward direction W.

The bezel members provided in the two lamp modules for a vehicle adjacent to each other may be provided to be in contact with each other.

In a general aspect, a lamp module for a vehicle includes: a light source configured to emit light; a bezel member configured to accommodate therein the light source; and a lens member fixed to a front side of the bezel member, wherein the lens member comprises a plurality of cylinder lenses extending in an upward/downward direction H and arranged in a leftward/rightward direction W, wherein each of the plurality of cylinder lenses each comprises a cylinder incident surface into which light emitted from the light source is introduced, and a cylinder emergent surface spaced apart forward from the cylinder incident surface, wherein an opening hole is formed in a front region of the bezel member, and the lens member is inserted into the opening hole, and wherein the bezel member includes an upper surface region configured to define an upper surface of the bezel member and extending in a forward/rearward direction A, a lower surface region configured to define a lower surface of the bezel member and extending in the forward/rearward direction A, and a front connection region configured to connect the upper surface region and the lower surface region and define the opening hole.

The shapes of horizontal cross-sections of the cylinder incident surfaces of some of the plurality of cylinder lenses may be different from shapes of horizontal cross-sections of the cylinder incident surfaces of some of the other cylinder lenses.

The bezel member and the lens member may be integrated.

The bezel member and the lens member may have different materials or colors.

The bezel member may include an opaque material, wherein the lens member may include a light transmissive material.

The bezel member and the lens member may include a light transmissive material, wherein the lamp module may further include a light-blocking layer provided on an outer or inner surface of the bezel member.

The bezel member may have a shape in which a width between the upper surface region and the lower surface region in the upward/downward direction H decreases forward.

A thickness in the leftward/rightward direction W of each of portions of the front connection region, which surround the opening hole and are provided on left and right portions of the opening hole, is smaller than a thickness in the upward/downward direction H of each of portions of the front connection region that surround the opening hole, wherein the portions of the front connection may be provided on upper and lower portions of the opening hole.

The front connection region may be provided to surround upper and lower portions of the opening hole, wherein the opening hole may be open in the leftward/rightward direction.

The cylinder incident surfaces of at least some of the plurality of cylinder lenses may have a concave lens shape.

The cylinder incident surfaces of some of the other cylinder lenses may have a convex lens shape.

The cylinder incident surfaces provided in the plurality of cylinder lenses may have a concave lens shape.

In another general aspect, a lamp for a vehicle includes lamp modules that are arranged in the leftward/rightward direction W.

The bezel members may be provided in at least two of the lamp modules that are adjacent to each other or in contact with each other.

According to the present disclosure, it is possible to solve a problem of a non-uniform light-emitting surface of the lamp for a vehicle to which the plurality of lamp modules are applied.

### BRIEF DESCRIPTION OF THE DRAWINGS

FIG. 1 is a vertical cross-sectional view of a lamp module for a vehicle according to the present disclosure.

FIG. 2 is a perspective view of the lamp module for a vehicle according to the present disclosure.

FIG. 3 is a horizontal cross-sectional view of a first example of the lamp module for a vehicle according to the present disclosure.

FIG. 4 is an enlarged view illustrating a part of a lens member in FIG. 3.

FIG. 5 is a horizontal cross-sectional view of a second example of the lamp module for a vehicle according to the present disclosure.

FIG. 6 is an enlarged view illustrating a part of a lens member in FIG. 5.

### DETAILED DESCRIPTION

Hereinafter, a lamp module for a vehicle and a lamp for a vehicle according to the present disclosure will be described with reference to the drawings.

### Lamp Module for Vehicle

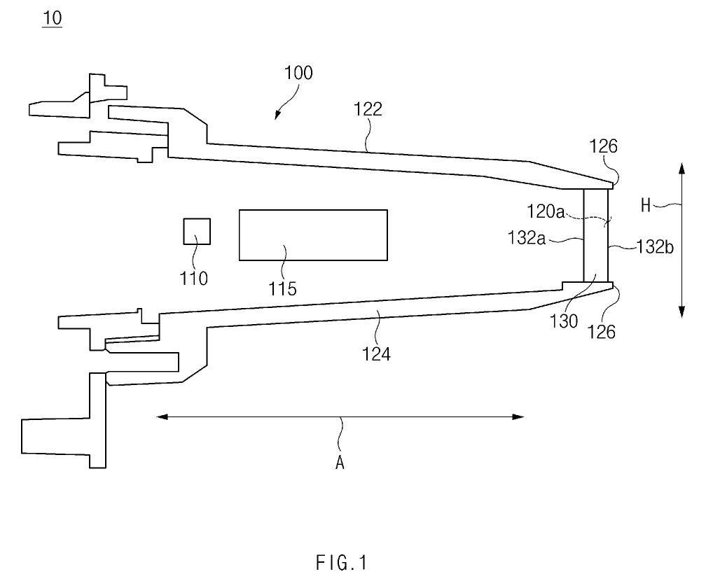

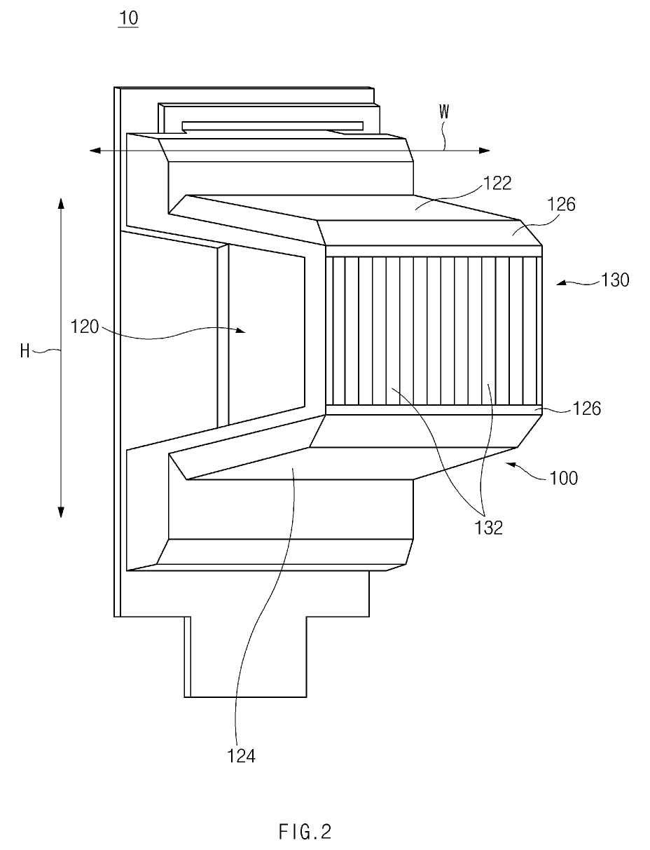

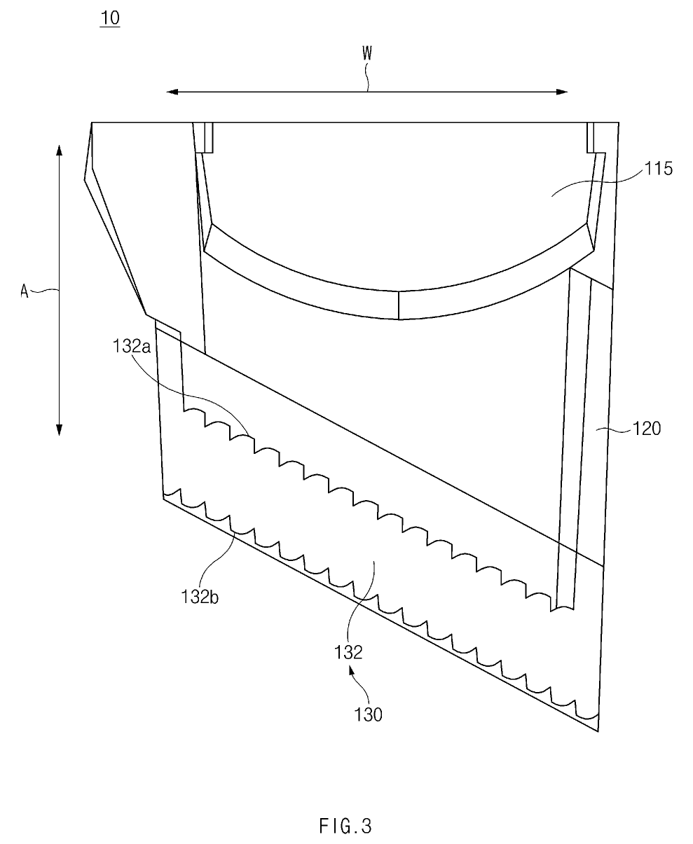

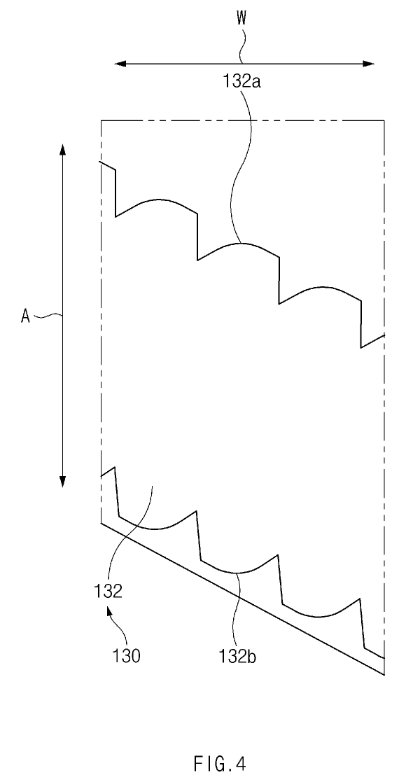

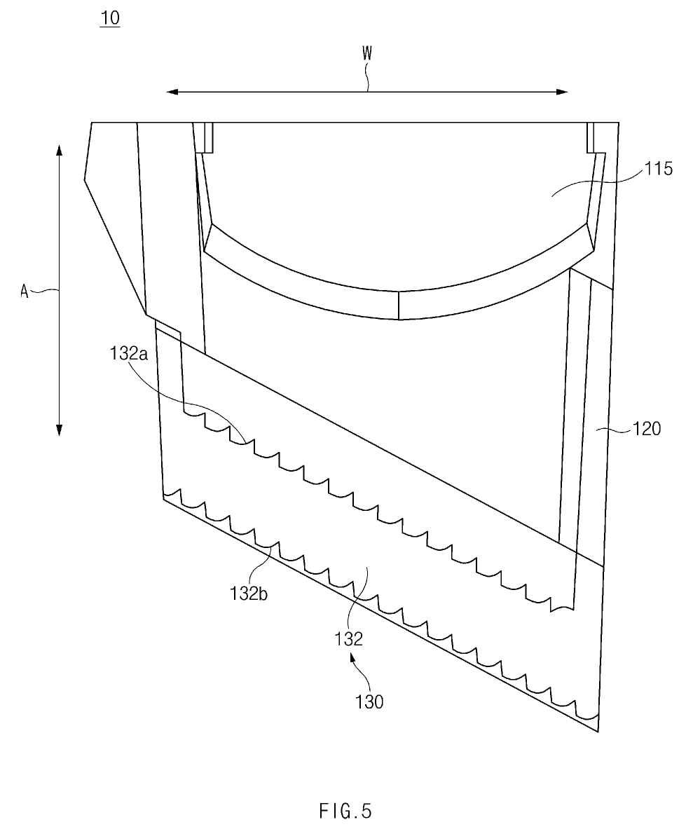

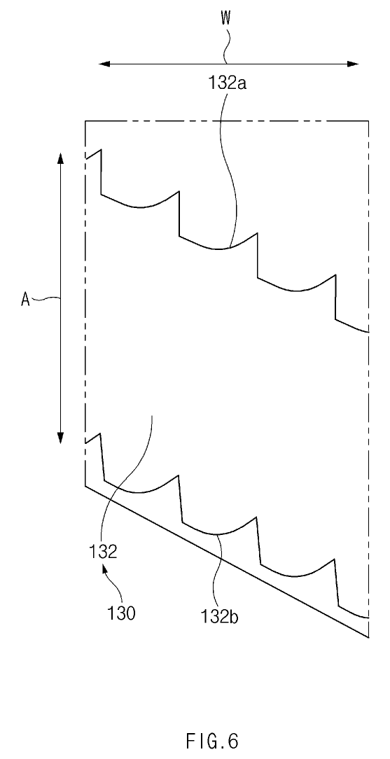

FIG. 1 is a vertical cross-sectional view of a lamp module for a vehicle according to the present disclosure, and FIG. 2 is a perspective view of the lamp module for a vehicle according to the present disclosure. FIG. 3 is a horizontal cross-sectional view of a first example of the lamp module for a vehicle according to the present disclosure, and FIG. 4 is an enlarged view illustrating a part of a lens member in FIG. 3. FIG. 5 is a horizontal cross-sectional view of a second example of the lamp module for a vehicle according to the present disclosure, and FIG. 6 is an enlarged view illustrating a part of a lens member in FIG. 5.

With reference to FIGS. 1 and 2, a lamp module 100 for a vehicle (hereinafter, referred to as a 'lamp module') according to the present disclosure may include a light source 110 configured to emit light, and a bezel member 120 configured to accommodate therein the light source. The bezel member 120 may be configured to allow the lamp module 100 to be fixed to another portion of a vehicle. The bezel member 120 may be configured to define a space in which the light source 110 is accommodated.

In addition, the lamp module 100 may further include a lens member 130 fixed to a front side of the bezel member 120. The lens member 130 according to the present disclosure may be a micro-cylinder lens. The micro-cylinder lens may have a structure in which a plurality of cylinder lenses are arranged in one direction. That is, the lens member 130 may include a plurality of cylinder lens units 132 extending in an upward/downward direction H of the lamp module 100 and arranged in a leftward/rightward direction W. A width of the cylinder lens unit 132 provided in the lens member 130 may be in a range of several tens of micrometers to several hundreds of micrometers.

FIG. 3 is a horizontal cross-sectional view of the first example of the lamp module for a vehicle according to the present disclosure, and FIG. 4 is an enlarged view illustrating a part of the lens member in FIG. 3. FIG. 5 is a horizontal cross-sectional view of the second example of the lamp module for a vehicle according to the present disclosure, and FIG. 6 is an enlarged view illustrating a part of the lens member in FIG. 5.

With reference to FIGS. 3 to 6, the plurality of cylinder lens units 132 provided in the lens member 130 may each include a cylinder incident surface 132a into which light emitted from the light source 110 is introduced, and a cylinder emergent surface 132b spaced apart forward from the cylinder incident surface 132a. The cylinder incident surface 132a and the cylinder emergent surface 132b may each have a convex or concave column shape.

As illustrated in FIGS. 3 and 4, according to one example of the present disclosure, shapes of horizontal cross-sections of the plurality of cylinder incident surfaces 132a provided in the plurality of cylinder lens units 132 may correspond to one another or be substantially identical to one another.

In contrast, as illustrated in FIGS. 5 and 6, according to another example of the present disclosure, the shapes of the horizontal cross-sections of the cylinder incident surfaces 132a of some of the plurality of cylinder lens units 132 may be different from the shapes of the horizontal cross-sections of the cylinder incident surfaces 132a of some of the other cylinder lens units 132.

More specifically, as illustrated in FIGS. 5 and 6, according to another example of the present disclosure, the cylinder incident surfaces 132a of at least some of the plurality of cylinder lens units 132 in the lens member 130 may each have a concave lens shape. More particularly, the cylinder incident surfaces 132a provided in the plurality of cylinder lens units 132 may each have a concave lens shape. However, unlike the above-mentioned configuration, the cylinder incident surfaces 132a of some of the plurality of cylinder lens units 132 may each have a concave lens shape, and the cylinder incident surfaces 132a of some of the other cylinder lens units 132 may each have a convex lens shape.

Meanwhile, as illustrated in FIGS. 1 and 2, an opened opening hole 120a may be formed in a front region of the bezel member 120, and the lens member 130 may have a structure inserted into the opening hole 120a.

For example, the bezel member 120 and the lens member 130 may be integrated. In this case, the bezel member 120 and the lens member 130 may have different materials or colors. In this case, the bezel member 120 and the lens member 130 may be manufactured together by a dual injection molding method.

Meanwhile, according to one example of the present disclosure, the bezel member 120 may include an opaque material, and the lens member 130 may include a light transmissive material. This is intended to allow the light emitted from the light source 110 to propagate to the outside through the lens member 130 without propagating to the outside through the bezel member 120, thereby preventing the light from reaching an undesired region.

In contrast, unlike the above-mentioned configuration, the bezel member 120 and the lens member 130 may each include a light transmissive material. In this case, the lamp module 100 may further include a light-blocking layer (not illustrated) provided on an outer or inner surface of the bezel member 120. The light-blocking layer may prevent the light from propagating to the outside through the bezel member 120 made of a light transmissive material.

Hereinafter, a detailed shape of the bezel member 120 will be described.

With reference back to FIGS. 1 and 2, the bezel member 120 may include an upper surface region 122 configured to define an upper surface of the bezel member 120 and extending in a forward/rearward direction A, a lower surface region 124 configured to define a lower surface of the bezel member 120 and extending in the forward/rearward direction A, and a front connection region 126 configured to connect the upper surface region 122 and the lower surface region 124 and define the opening hole 120a. Therefore, the lens member 130 may be fixed to the bezel member 120 in the state in which the lens member 130 is inserted into the opening hole 120a.

In addition, for example, the bezel member 120 may have a shape in which a width between the upper surface region 122 and the lower surface region 124 in the upward/downward direction H decreases forward.

Meanwhile, according to the present disclosure, a thickness in the leftward/rightward direction W of each of portions of the front connection region 126, which surround the opening hole 120a and are provided on left and right portions of the opening hole 120a, may be smaller than a thickness in the upward/downward direction H of each of portions of the front connection region 126 that surround the opening hole 120a and are provided on upper and lower portions of the opening hole 120a. As described below, the plurality of lamp modules 100 according to the present disclosure may be arranged in the leftward/rightward direction W. In case that the thickness in the leftward/rightward direction W of each of the portions of the front connection region 126 provided on the left and right portions is relatively small as described above, the connectivity between the light-emitting surfaces formed by the two lamp modules 100 provided adjacent to each other in the leftward/rightward direction W may be improved.

In contrast, unlike the above-mentioned configuration, the front connection region 126 may be provided to surround the upper and lower portions of the opening hole 120a, and the opening hole 120a may be open in the leftward/rightward direction. It may be understood that the front connection region 126 is formed only on the upper and lower portions of the opening hole 120a. In this case, when the lamp module is viewed from the front side, a proportion of a portion occupied by the lens member 130 in the leftward/rightward direction may be further increased. Therefore, in case that the plurality of lamp modules are disposed in the leftward/rightward direction as described below, the connectivity between the light-emitting surfaces formed by the lamp modules may be further improved.

### Lamp for Vehicle

According to the present disclosure, a lamp 10 for a vehicle may include the plurality of lamp modules 100, and the plurality of lamp modules 100 may be arranged in the leftward/rightward direction W. The description of the lamp module 100 provided in the lamp 10 for a vehicle according to the present disclosure may be replaced with the description of the lamp module according to the present disclosure described above with reference to FIGS. 1 to 6.

Meanwhile, in the lamp 10 for a vehicle according to the present disclosure, the bezel members 120 provided in the two lamp modules 100 for a vehicle that are adjacent to each other in the leftward/rightward direction W may be provided to be in contact with each other. In this case, the connectivity between the light-emitting surfaces formed by the lamp modules 100 may be improved.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A lamp module for a vehicle, the lamp module comprising:
a light source configured to emit light;
a bezel member configured to accommodate therein the light source; and
a lens member fixed to a front side of the bezel member,
wherein the lens member comprises a plurality of cylinder lenses extending in an upward/downward direction H and arranged in a leftward/rightward direction W,
wherein each of the plurality of cylinder lenses each comprises:
a cylinder incident surface into which light emitted from the light source is introduced; and
a cylinder emergent surface spaced apart forward from the cylinder incident surface,
wherein an opening hole is formed in a front region of the bezel member, and the lens member is inserted into the opening hole, and
wherein the bezel member comprises:
an upper surface region configured to define an upper surface of the bezel member and extending in a forward/rearward direction A;
a lower surface region configured to define a lower surface of the bezel member and extending in the forward/rearward direction A; and
a front connection region configured to connect the upper surface region and the lower surface region and define the opening hole.

2. The lamp module of claim 1, wherein shapes of horizontal cross-sections of the cylinder incident surfaces of some of the plurality of cylinder lenses are different from shapes of horizontal cross-sections of the cylinder incident surfaces of some of the other cylinder lenses.

3. The lamp module of claim 1, wherein the bezel member and the lens member are integrated.

4. The lamp module of claim 1, wherein the bezel member and the lens member have different materials or colors.

5. The lamp module of claim 1, wherein the bezel member includes an opaque material, and
wherein the lens member includes a light transmissive material.

6. The lamp module of claim 1, wherein the bezel member and the lens member include a light transmissive material, and
wherein the lamp module further comprises a light-blocking layer provided on an outer or inner surface of the bezel member.

7. The lamp module of claim 1, wherein the bezel member has a shape in which a width between the upper surface region and the lower surface region in the upward/downward direction H decreases forward.

8. The lamp module of claim 1, wherein a thickness in the leftward/rightward direction W of each of portions of the front connection region, which surround the opening hole and are provided on left and right portions of the opening hole, is smaller than a thickness in the upward/downward direction H of each of portions of the front connection region that surround the opening hole, and
wherein the portions of the front connection are provided on upper and lower portions of the opening hole.

9. The lamp module of claim 1, wherein the front connection region is provided to surround upper and lower portions of the opening hole, and
wherein the opening hole is open in the leftward/rightward direction.

10. The lamp module of claim 1, wherein the cylinder incident surfaces of at least some of the plurality of cylinder lenses have a concave lens shape.

11. The lamp module of claim 10, wherein the cylinder incident surfaces of some of the other cylinder lenses have a convex lens shape.

12. The lamp module of claim 1, wherein the cylinder incident surfaces provided in the plurality of cylinder lenses have a concave lens shape.

13. A lamp for a vehicle, the lamp comprising:
a plurality of lamp modules for a vehicle according to claim 1,
wherein the plurality of lamp modules for a vehicle are arranged in the leftward/rightward direction W.

14. The lamp of claim 13, wherein the bezel members provided in at least two of the lamp modules for a vehicle adjacent to each other are provided to be in contact with each other.
